(19) United States
(12) Patent Application Publication
(10) Pub. No.: US 2016/0275452 A1
(43) Pub. Date: Sep. 22, 2016

(54) Internet newspaper wire feed

(71) Applicant: Michael Lewis Moravitz, Fairfax, VA (US)

(72) Inventor: Michael Lewis Moravitz, Fairfax, VA (US)

(21) Appl. No.: 14/999,542

(22) Filed: May 23, 2016

(51) Int. Cl. G06Q 10/10; H04L 29/08

(52) U.S. Cl. CPC G06Q 10/10; H04L 67/26

(57) ABSTRACT

Newspapers should provide subscription wire feeds to radio and television stations, and other publications.

Newspapers and magazines should provide subscription feed services over the Internet to particular radio and television broadcasts and other publications.

This might clarify when an article would run on the wire and then on the website, as well as ensure more control over broadcast and republication rights for newspapers and magazines. A bundle of publications might send their articles over a certain wire feed that is established for a particular publication group or alliance. First rights would go to those who pay their feeds. Only later might the articles appear on the website and then the publication itself. This might also apply to certain television and radio networks as well who want to highlight a particular report or interview of theirs in print form. This would make news operations and a range of publications more profitable. This might be another way forward for some publications in the new era of the Internet—instead of providing so much material, essentially for free except for advertisements, on websites. Some publications might provide a free wire service under a different business or institutional model.

1) Wire service feed software; and

2) Devices.
